(19) United States
(12) Patent Application Publication
(10) Pub. No.: US 2007/0203738 A1
(43) Pub. Date: Aug. 30, 2007

(54) Method and apparatus for providing a rewards-based feedback incentive mechanism

(76) Inventor: Michael S. Jaschke, Deerfield Beach, FL (US)

Correspondence Address: BRINKLE Y, MORGAN, SOLOMON, TATUM, STANLEY, LUNNY,;& CROSBY, LLP, 200 E. LAS OLAS BLVD, SUITE 1900, FORT LAUDERDALE, FL, 33301, US

(21) Appl. No.: 11/699,185

(22) Filed: Jan. 29, 2007

Related U.S. Application Data
(60) Provisional application No. 60/776,615, filed on Feb. 27, 2006.

(51) Int. Cl. G06Q 10/00; G06Q 30/00

(52) U.S. Cl. 705/1

(57) ABSTRACT

A rewards-based feedback incentive program allows registered feedback providers to receive credits redeemable at multiple registered businesses in exchange for providing usable feedback to one or more of the businesses. A processor receives a request from a registered business to provide at least one universal credit to a registered feedback provider in response to the business accepting feedback from the feedback provider. Each credit is redeemable toward coupons issued by any of the registered businesses. The processor credits the feedback provider with the requested credits and enters an electronic coupon in a data record relating to the business. The coupon is valued at a number of credits corresponding to the requested credits, another amount of credit at the discretion of the business, or as provided in an agreement amongst the businesses. The coupon is redeemable by any of the registered feedback providers having at least the number of universal credits.

### CROSS-REFERENCE TO RELATED APPLICATIONS

This application claims priority under 35 U.S.C. §119(e)(1) upon U.S. Application Ser. No. 60/776,615, which is entitled “Business Directory Service Using a Rewards Based Customer Endorsement Mechanism” and is incorporated herein by this reference.

### BACKGROUND OF THE INVENTION

1. Field of the Invention

The present invention relates generally to customer feedback programs and, more particularly, to a method and apparatus for acquiring from past customers and providing to potential customers performance information concerning businesses by offering past customers an expansive reward redemption system in exchange for the customer's provision of acceptable feedback.

2. Description of the Prior Art

Every business needs feedback from customers and stakeholders in order to grow. Today companies use customer relationship management (CRM), customer experience management (CEM) and conventional market research methods in order to find out what others think about their brands, products, and services, and how to best serve them.

The most crucial issue remains how to engage customers and other stakeholders to provide a steady stream of valuable feedback that helps businesses excel while at the same time creating customer loyalty. Focus groups and interview projects are expensive, require substantial lead time and provide only sporadic feedback. They are not suitable to increase customer loyalty. Surveys, questionnaires and feedback forms provide valuable results only if combined with a rewards system that encourages feedback providers to participate. The most effective rewards today are coupons or loyalty programs. Available systems are expensive, complex to implement and maintain and offer only little flexibility. Shared loyalty programs charge substantial transaction fees.

Many companies do not have the financial resources to either buy and administer such systems or participate in an existing loyalty program. Single company loyalty programs provide incentives only for existing customers, making them unsuitable to attract new customers.

The rise of the Internet has been both a godsend and a curse for consumers. While today's savvy web surfer can easily investigate any company, the data gleaned is usually just the basics. There is still no way to tell which business is legitimate or trustworthy and which one a consumer should avoid. The “Dot Bomb” era of the 1990s clearly demonstrated that even the best-funded companies could go out of business the very next day, leaving customer orders unfilled, products non-returnable, and life savings lost.

Of course, businesses that have offered consumers poor service, poor quality, or poor experiences have been around since the first merchant stalls opened for business shortly after man began to walk upright. In the brick and mortar world, these poor businesses eventually close their doors. The lack of patronage usually decides the fate of a traditional business. However, even in the “real world,” unscrupulous businesses can deceive customers. Witness the numerous contractors who descended upon hurricane-ravaged areas following Katrina, only to disappear into the night with hefty deposits for home repairs that were never completed.

Even in an age of technological advances, increased security and anti-identity theft measures, consumers are still largely left to fend for themselves when making purchases on a day-to-day basis, whether it is in their own neighborhood or on the world market of the Internet. It really comes as no surprise that trust continues to be one of the main things consumers want from a business. They want to be assured that the businesses they are patronizing are “on the up and up,” that the business will back its products with solid customer service, that problems will be resolved quickly, and that the products or services themselves are of the highest quality for the price.

In case of the online world, the growth in ecommerce brings with it a significant increase in the variety of fraudulent Web activities hurting legitimate online businesses with an ever decreasing level of consumer trust. Studies indicate that approximately 70% of online shoppers have terminated an online order because they did not “trust” the transaction and 54% of online shoppers are more concerned about the security of their personal data in 2005, up 10 percent from 2004. (Source: A study by TNS, conducted in April 2005 and sponsored by VeriSign).

The conclusion is simple: consumers and legitimate businesses need to find new ways to increase trust and create long term customer loyalty. One of the best ways to achieve this goal for businesses is to make feedback of past customers available for potential new customers.

One way to make such information available is through directory services. While directory services exist today, most offer only contact information (e.g., address and telephone number(s)) and advertising concerning businesses. Some directory services offer customer ratings for the quality of goods or services offered by each business by accepting feedback from former customers. However, obtaining objective feedback from former customers may be difficult to accomplish.

Generally, as customers are not compensated for providing feedback, very few customers feel compelled to take the time to endorse businesses. Often, feedback received from former customers occurs when the customer has had a negative experience with the business and wishes to complain. As a result, the total amount of endorsements for businesses is very low, skewing the overall rating of a business and presenting difficulties for a consumer attempting to make an informed decision regarding whether to engage a particular business.

Some businesses may offer incentives to customers in an attempt to entice the customer to provide feedback. However, offered incentives are generally in the form of coupons redeemable at a future date for discounted goods or services of the business attempting to solicit feedback. When the customer has already purchased a good or service from a business, especially in the case where the good is an expensive item designed to last a long time (e.g., appliances, air conditioning units, televisions, etc.) or the service is not required on a routine basis (e.g., house painting, carpet installation, roof cleaning, etc.), the promise of a discount on the same or similar item at some remote time in the future may not be compelling enough to warrant the expenditure of time required to provide feedback.

Therefore, a need exists for, among other things, a method for providing potential customers with detailed performance information concerning businesses and for businesses to obtain detailed feedback that helps them to grow, that overcomes the shortcomings of the prior art.

### SUMMARY OF THE INVENTION

An embodiment of the present invention includes a method for providing a rewards-based feedback incentive program in which customers provide and receive detailed performance information concerning businesses. Customers may search a database of businesses and receive search results displaying general business information supplemented with feedback (e.g., endorsements, or other positive or negative feedback) of former customers. This supplemental information allows customers to make better-educated decisions upon whether to enter into business relationships with businesses offering goods or services desired by the customers, but for which the customers have not had prior dealings.

Businesses choosing to use the method join a virtual business network and agree to adhere to well-defined principles by signing a terms and conditions statement provided during the registration process. Registered businesses award customers or other feedback providers with universal credits for use in purchasing or otherwise obtaining products and/or services based on feedback provided by customers on behalf of the business and at their request. The amount of universal credits awarded for each endorsement may vary depending on the business type of the endorsed business. For each award of universal credits that businesses award to customers, the business posts an electronic coupon for discounted products and/or services in their database entry. Customers who have earned universal credits may redeem those credits for any coupon of any business participating in the virtual business network, not just the business for which feedback has been provided.

Customers may search databases that contain data records of (1) businesses participating in a virtual business network and (2) businesses that do not participate in such a network. Both business types may be contained in the same database.

Due to the customer-driven nature of the virtual business network, the quality of the products and services offered by participating businesses is increased. Businesses receiving a high number of endorsements may thrive, while others who either do not perform (e.g., few endorsements or a large amount of negative feedback) or do not participate in the virtual business network are at a competitive disadvantage. Furthermore, customers who actively participate in the network receive discounted products and/or services. This incentive program encourages development of a community of customers who choose to buy products and/or services from businesses within the virtual business network, increasing the overall business volume of endorsed businesses, while at the same time reducing their mass marketing cost.

While directory services exist today, many offer only address and/or other contact information. Some of them offer customer ratings of businesses and services. But, as customers are not compensated for providing feedback, only very few customers feel compelled to endorse businesses and the total amount of endorsements for businesses is very low.

By using a credit-driven endorsement process, as provided by the present invention, registered customers are much more likely to provide substantial feedback about registered businesses.

In order to minimize the amount of fraud related to registered customers endorsing registered businesses only for the sake of receiving universal credits, registered businesses preferably invite former customers to join the network and endorse them. Furthermore customers are able to view all endorsements that any registered customer made allowing customers to decide on their own on the quality of each endorsement.

### BRIEF DESCRIPTION OF THE DRAWINGS

FIG. 1 is a block diagram of a virtual business network system, in accordance with one embodiment of the present invention.

FIG. 2 is an exemplary relational database showing data structures for business data records, customer data records, endorsements and coupons, in accordance with an embodiment of the present invention.

FIGS. 3 and 4 are logic flow diagrams illustrating steps executed by a directory processor and/or a directory provider to implement methods for providing a rewards-based customer feedback incentive program in accordance with exemplary embodiments of the present invention.

FIG. 5 is an electrical block diagram of an exemplary directory processor in accordance with one embodiment of the present invention.

### DETAILED DESCRIPTION OF EXEMPLARY EMBODIMENT(S)

Before describing in detail exemplary embodiments that are in accordance with the present invention, it should be observed that the embodiments reside primarily in combinations of apparatus components and processing steps related to implementing an apparatus and method for rewards-based customer feedback incentive program. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, may be used solely to distinguish one entity or element from another entity or element without necessarily requiring or implying any physical or logical relationship or order between such entities or elements. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. The term “plurality of” as used in connection with any object or action means two or more of such object or action. A claim element proceeded by the article “a” or “an” does not, without more constraints, preclude the existence of additional identical elements in the process, method, article, or apparatus that includes the element.

Additionally, as used herein and in the appended claims, the term “virtual business network” includes a single business and/or a multitude of related and/or non-related businesses having a formal agreement to honor universal credits towards the purchase of products and/or services awarded to customers by businesses participating in the virtual business network, based on the availability of coupons. A “coupon” is an entitlement to certain specified discounts on products and/or services offered by a business participating in the virtual business network to customers who have acquired a specified number of universal credits. “Discounted products and/or services” include, but are not limited to, products and/or services discounted by a fixed amount of money, products and/or services discounted by a relative percentage of the purchase price, and complementary products and/or services. Additionally, a “universal credit” is a credit issued to certain customers, which may be used to purchase or otherwise obtain discounted products and/or services from any business participating in the virtual business network that has posted one or more coupons in the virtual business network.

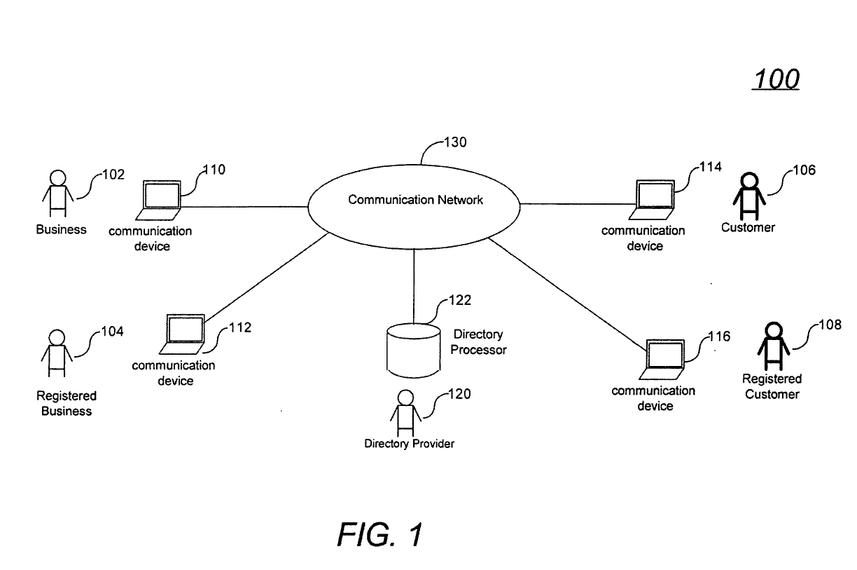

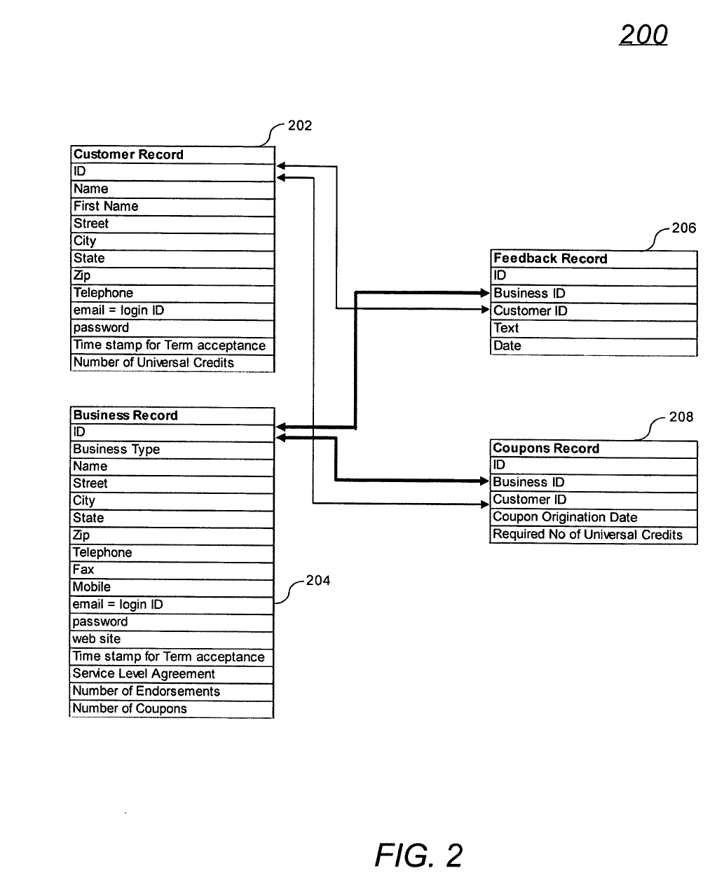

The present invention can be more readily understood with reference to FIGS. 1-4, in which like reference numerals designate like items. FIG. 1 illustrates a block diagram of an exemplary virtual business network 100 illustrating the relationship of all transaction partners, network(s), processor(s) and customer premise equipment, which are involved in the virtual business network. FIG. 2 depicts an exemplary relational database 200 stored in the directory processor 122 of the virtual business network 100. One of ordinary skill in the art will readily recognize and understand that the structure and content of the relational database 200 illustrated in FIG. 2 may vary depending on the specific implementation.

In one embodiment of the present invention, a computer system provides communication links over a communication network 130 and provides a user interface to query a database 200. The communication network 130 is a data network including, but not limited to, the Internet, a text-messaging network, a short messaging network, etc.

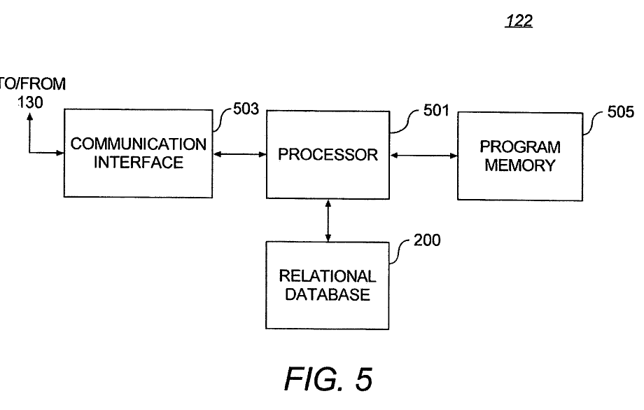

The directory provider 120 maintains a directory processor 122 which, as illustrated in block diagram form in FIG. 5, may include one or multiple processors 501, and various other elements, including, but not limited to: (1) one or more relational databases 200 containing information about businesses and/or customers, as illustrated in exemplary form in FIG. 2, (2) one or more user or communication interfaces 503 linked to the communication network 130 and allowing customers, businesses or administrators to access the databases 200, (3) one or more payment processors for the collection of payments, (4) one or more communication processors (e.g., email, instant messaging, short messaging service, text messaging, voice over IP, video over IP, voice mail, etc.) for communication purposes, and (5) a program memory 505 that stores application code for the management of endorsements and coupons, as well as the relational database 200.

The structure and generation of web pages, web interfaces, user and administrative interfaces, payment processors, communication processors, applications and relational databases is well understood by those skilled in the art.

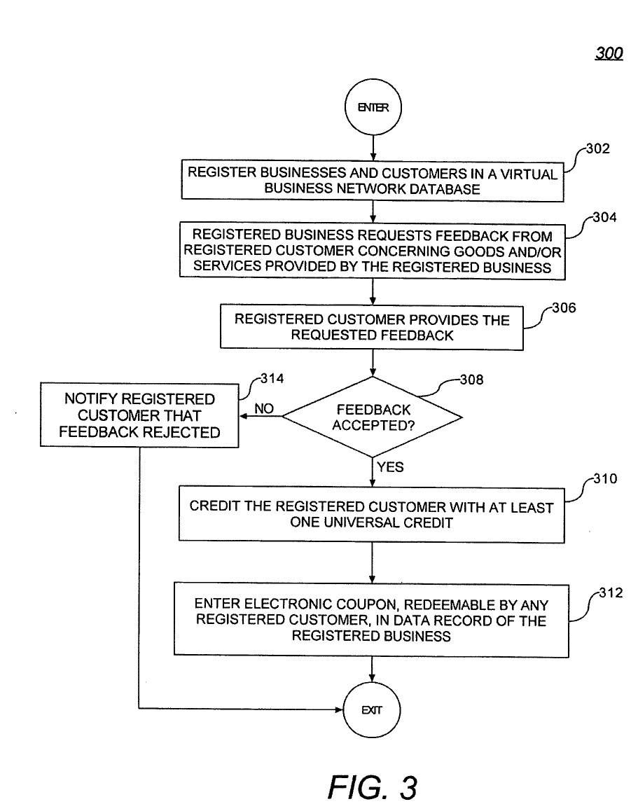

As illustrated in FIG. 2, the business database 200 may contain data records 204 for two types of businesses: businesses that participate in the virtual business network 100 (hereinafter referred to as “registered businesses” 104) and businesses 102 that do not yet or do not at all participate in the virtual network 100. Referring now to FIG. 3, a representative of a business 102 registers (302) the business 102 to participate in the virtual business network 100 by accessing the directory processor 122 via a communication device 110, 112 (e.g., a personal or laptop computer, a personal digital assistant (PDA), a data-capable mobile telephone, etc.). The directory processor 122 prompts the business 102 to electronically sign a terms and conditions statement provided by the directory processor 122. The business 102 only becomes a registered business 104 after signing the agreement. By registering with the directory processor 122, registered businesses 104 agree to accept universal credits from registered customers 108 for redemption of available coupons 208 posted in the data records 204 of any registered businesses 104. Registered businesses 104 further agree to compensate registered customers 108 or other feedback providers (e.g., employees, business partners, or any other person that interacts with the business), with universal credits when the registered customers 108 provide feedback (e.g., an endorsement, complaint, or other positive or negative feedback) based on the request of the registered businesses 104. The registered business 104 must accept the endorsement or other feedback in order for universal credits to be posted in the registered customer's data record 202. Registered businesses 104 are marked as such in the database 200 of the directory processor 122. Each registered business data record 204 contains a time stamp (time & date) of their acceptance of the terms and conditions of the virtual business network agreement. The directory provider 120 may charge registered businesses 104 a fee in order to participate in the virtual business network 100.

In one embodiment, customers accessing the database may or may not be registered customers 108. Information concerning registered customers 108 is entered into a customer data record 202 of the database 200, containing among other customer information, references to endorsements and universal credits. While any customer 106 is able to see all contact and performance (feedback) information contained in each business data record 204, only registered customers 108 are able to endorse businesses, earn credits, and redeem coupons 208. The directory provider 120 may optionally charge registered customers 108 a fee in order to use the advantages of endorsing registered businesses 104 and redeeming coupons 208.

Customers 106, 108 may access the directory provider's database 200 by accessing the directory processor 122 through a user interface via communication devices 114, 116 (e.g., personal computers or laptops with Internet connection, Wireless Fidelity (WiFi) enabled communication devices, fixed and mobile telephones with short messaging service, text messaging, instant messaging, or Internet connection).

While or after conducting business with a registered customer 108, the registered business 104 may decide to ask the registered customer 108 or other feedback provider to provide feedback concerning the goods and/or services provided by the registered business 104. To request such feedback, the registered business 104 sends (304) (e.g., via email, posting to the registered customer's account, or otherwise) an endorsement request to the registered customer 108 using the communication mechanism of the directory processor 122.

If the registered customer 108 decides to provide (306) feedback concerning the registered business 104, he/she composes the feedback and provides it to the directory processor 122, which is transmitted to the registered business 104 using the communication mechanism of the directory processor 122 and stored (along with other relevant information, such as the customer's ID, the registered business' ID, and the date) as a feedback record 206 in the database 200 of the directory processor 122.

If the registered business 104 decides (308) to accept the feedback 206, it acknowledges the feedback record 206 through the directory processor 122. The registered customer 108 receives a notice of acknowledgement through the communication mechanism of the directory processor 122. The registered customer 108 is then issued and receives (310) the appropriate amount of universal credits on his/her account. The amount of universal credits may depend on the business type (e.g., businesses offering more expensive goods or specialized services may offer higher universal credit amounts than businesses offering inexpensive goods or commonplace services). The directory processor 122 enters (312) a coupon 208 to the data record 204 of the registered business 104.

If the registered business 104 decides (308) to reject the feedback 206, the registered customer 108 receives (314) a notice of rejection through the communication mechanism of the directory processor 122.

If the customer 106 is not a registered customer 108, the registered business 104 may decide to invite the customer 106 to join the virtual network 100 by contacting the customer 106 directly or by using the communication mechanism of the directory processor 122. One of ordinary skill in the art will readily recognize that the operation of the directory processor 122 to implement the logic flow of FIG. 3 may be controlled by a software application or other set of computer-readable instructions stored in the program memory 505 or other memory of the directory processor 122.

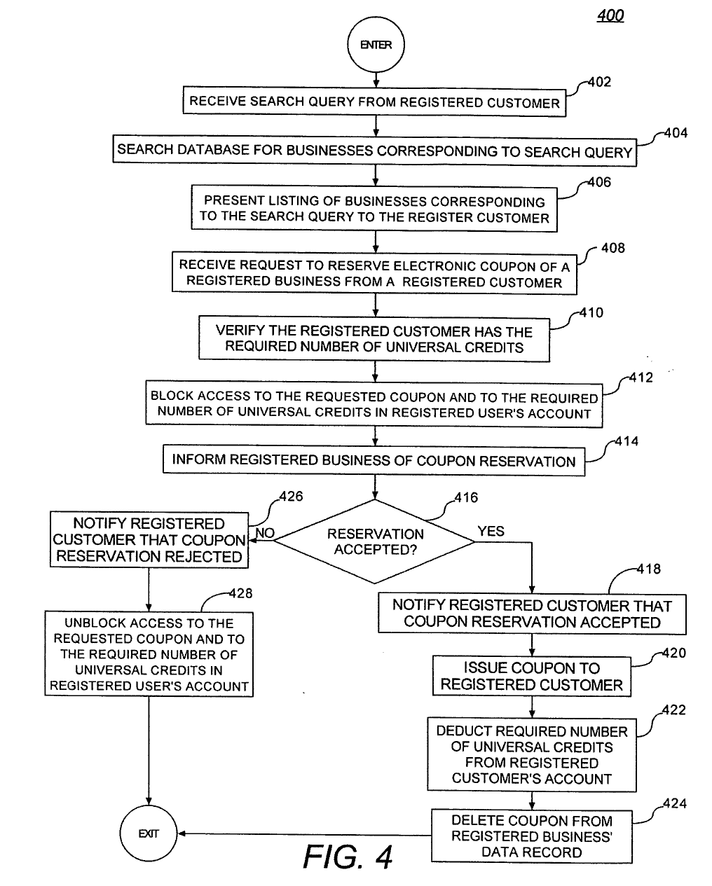

In another embodiment, as illustrated in logic flow form in FIG. 4, once customers access the directory processor's user interface they may query (402) the database 200 by searching for specific business names, keywords, or business types. They may further narrow their search down by specifying a geographic area in which such businesses offer their products and services. The directory processor 122 searches (404) the database 200 for businesses corresponding to the search query and returns (406) a list of all businesses in the database 200 that fulfill the search criteria. The search result may contain data records 204 consisting of all basic business information, including contact information, all endorsements and all coupons related to each business entry.

The search results may be sorted by any data field, including, but not limited to, business name, business type, location of business, distance to customer, number of endorsements, and number of available coupons.

Customers may review lists of search results, whereby each data record 204 is summarized showing essential information, such as business name, address information, contact information, distance to customer, number of endorsements, number of available coupons, description of each available coupon, etc. Customers may review each data record 204 in more detail by looking at all or a subset of all information contained in the data record 206 of endorsements of any selected business. They may also review all or a subset of endorsements 206 that a specific customer has made or any other information contained in the database 200 and that the directory provider 120 has decided to make available to customers 106, 108.

The directory processor 122 may also provide a communication mechanism that includes one or more digital communication methods, including but not limited to, email, short messaging service (SMS), instant messaging, text messaging, voice over IP, voice mail, video over IP, etc. Customers deciding to do business with one or more businesses returned in the search results may use the contact information provided by the database 200 in order to contact the chosen businesses. They may use the directory processor's communication mechanism in order to contact the business (e.g., through the directory provider's website).

If the customer is a registered customer 108 of the directory processor 122 and has already earned one or more universal credits for the redemption of coupons, the registered customer 108 may decide to redeem universal credits for a coupon from a registered business 104 having available coupons 208 in its record. In that case, the directory processor 122 receives (408) a request from the registered customer 108 to reserve a coupon. The directory processor 122 verifies (410) the availability of the required universal credits by accessing the data record 202 of the registered customer 108. If the registered customer 108 has the required amount of universal credits, the directory processor 122 blocks (412) access to both the required universal credits of the registered customer 108 and the coupon of the registered business 104 for reservation and informs (414) the registered business 104 that a coupon has been reserved using the communication mechanism of the directory processor 122.

If the registered business 104 decides (416) to do business with the registered customer 108 requesting the coupon, the registered business 104 acknowledges the reservation. The directory processor 122 informs (418) the registered customer 108 that the reservation has been successful by using the communication mechanism of the directory processor 122 and issues (420) an electronic coupon to the registered customer 108. The required universal credits are deducted (422) from the account of the registered customer 108 and the coupon 208 of the registered business 104 is deleted (424) from the database 200 of the directory processor 122.

If the registered business 104 decides (416) not to do business with the registered customer 108 requesting the coupon, the registered business 104 rejects the reservation. The directory processor 122 informs (426) the registered customer 108 that the reservation has been rejected using the communication mechanism of the directory processor 122. The directory processor 122 unblocks (428) the required universal credits of the registered customer 108 and the coupon 208 of the registered business 104 and makes them available for other reservations.

The registered customer 108 may cancel the reservation through the directory processor 122 up to the point when the registered business 104 has accepted the reservation. In the case of a timely cancellation, the directory processor 122 informs the registered business 104 of the cancellation by the registered customer 108 and makes both the blocked coupon of the registered business 104 and the blocked universal credits of the registered customer 108 available for other reservations.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made during the pendency of this application and all equivalents of those claims as issued.

What is claimed is:

1. A method for providing a rewards-based feedback program, the method comprising:
registering businesses and feedback providers in a database to produce a plurality of registered businesses and a plurality of registered feedback providers;
receiving a request from a registered business of the plurality of registered businesses to provide at least one universal credit to a registered feedback provider of the plurality of registered feedback providers in response to the registered business accepting feedback from the registered feedback provider, wherein each universal credit is redeemable toward goods or services provided by any of the plurality of registered businesses;
crediting an account in the database relating to the registered feedback provider with the at least one universal credit; and
entering at least one electronic coupon in a data record of the database relating to the registered business, each electronic coupon being valued at a corresponding number of universal credits and being redeemable by any of the plurality of registered feedback providers having been credited at least the corresponding number of universal credits.

2. The method of claim 1, further comprising;
prior to receiving the request from the registered business to provide the at least one universal credit, receiving a request from the registered business for feedback from the registered feedback provider concerning at least one of goods and services provided by the registered business; and
sending the request to the registered feedback provider.

3. The method of claim 2, further comprising:
receiving feedback from the registered feedback provider concerning at least one of goods and services provided by the registered business;
forwarding the feedback to the registered business; and
receiving an acknowledgement from the registered business that the feedback has been accepted.

4. The method of claim 1, wherein the feedback is at least one of positive feedback, negative feedback, and an endorsement.

5. The method of claim 1, further comprising:
charging at least one of businesses and feedback providers a fee for registering in the database.

6. The method of claim 1, wherein the plurality of registered businesses includes businesses offering different types of goods and services.

7. The method of claim 1, further comprising:
receiving a search query from a potential feedback provider, the query containing at least one of a business name, a business type, and at least one keyword;
searching the database for registered businesses corresponding to the search query; and
presenting a listing of registered businesses corresponding to the search query to the potential feedback provider, the listing containing information related to each registered business listed therein.

8. The method of claim 7, wherein the information related to each registered business includes at least one of a business name, a business type, a location of the business, a distance from the business to the potential feedback provider, a quantity of feedback entries, a quantity of available coupons issued by the business, and a description of each available coupon issued by the business.

9. The method of claim 1, further comprising:
receiving a request from the registered feedback provider to reserve an electronic coupon of a first registered business to produce a requested coupon, the requested coupon being stored in a data record of the first registered business and valued at a first predetermined number of universal credits;
verifying that the account of the registered feedback provider contains at least the first predetermined number of universal credits;
blocking access to the requested coupon and the first predetermined number of universal credits in the account of the registered feedback provider to produce a coupon reservation; and
informing the first registered business of the coupon reservation.

10. The method of claim 9, further comprising:
receiving an acknowledgement of the coupon reservation from the first registered business;
issuing the requested coupon to the registered feedback provider;
deducting the first predetermined number of universal credits from the account of the registered feedback provider;
deleting the requested coupon from the data record of the first registered business; and
informing the registered feedback provider that the coupon reservation has been successful.

11. The method of claim 9, further comprising:
receiving a rejection of the coupon reservation from the first registered business;
unblocking access to the requested coupon and the first predetermined number of universal credits in the account of the registered feedback provider; and
informing the registered feedback provider that the coupon reservation has been rejected.

12. A method for a potential feedback provider to participate in a rewards-based feedback incentive program, the method comprising:
registering to receive and redeem universal credits from a plurality of businesses registered in a virtual business network;
receiving a request to provide feedback concerning at least one of goods and services provided by a registered business;
providing the feedback; and
in the event that the feedback is accepted by the registered business, receiving at least one universal credit for use in obtaining at least one of goods and services from any of the plurality of registered businesses.

13. The method of claim 12, further comprising:
requesting an electronic coupon, the electronic coupon being offered by one of the plurality of registered businesses and valued at a predetermined number of universal credits; and
in the event that an account of the potential feedback provider contains at least the predetermined number of universal credits, receiving at least the electronic coupon.

14. A method for a business to participate in a rewards-based feedback program, the method comprising:
registering in a virtual business network that includes a plurality of registered businesses;
requesting feedback from a registered feedback provider regarding at least one of goods and services provided by the business;
receiving feedback from the registered feedback provider;
determining whether to accept the feedback; and
in the event that the feedback is accepted:
issuing at least one universal credit to the registered feedback provider, wherein each universal credit is redeemable toward goods or services provided by any of the plurality of registered businesses; and
issuing an electronic coupon valued at a predetermined number of universal credits and being redeemable by any registered feedback provider having been credited at least the predetermined number of universal credits.

15. The method of claim 14, further comprising:
prior to requesting feedback from the registered feedback provider, sending an invitation to a potential feedback provider to become a registered feedback provider so as to be eligible to receive and redeem universal credits from the plurality of registered businesses.

16. The method of claim 14, further comprising:
receiving a request from one of the registered feedback provider and a second registered feedback provider to reserve the electronic coupon; and
sending an acknowledgement accepting the request.

17. The method of claim 16, further comprising:
accepting the electronic coupon toward acquisition of at least one of goods and services offered by the business.

18. A rewards-based feedback incentive system comprising:
a processor for executing computer instructions;
a communication interface, operably coupled to the processor, for facilitating communications with communication devices operated by at least a plurality of feedback providers and a plurality of businesses;
a database, coupled to the processor, for storing information relating to the plurality of businesses and the plurality of feedback providers; and
a memory, operably coupled to the processor, the memory storing instructions that, when executed by the processor, cause the processor to:
register at least some of the plurality of businesses and the plurality of feedback providers in a database to produce a plurality of registered businesses and a plurality of registered feedback providers;
receive a request from a registered business of the plurality of registered businesses to provide at least one universal credit to a registered feedback provider of the plurality of registered feedback providers in response to the registered business accepting feedback from the registered feedback provider, wherein each universal credit is redeemable toward at least one of goods and services provided by any of the plurality of registered businesses;
credit an account in the database relating to the registered feedback provider with the at least one universal credit; and
enter at least one electronic coupon in a data record of the database relating to the registered business, each electronic coupon being valued at a corresponding number of universal credits and being redeemable by any of the plurality of registered feedback providers having been credited at least the corresponding number of universal credits.

19. The rewards-based feedback incentive system of claim 18, wherein the memory stores additional instructions that, when executed by the processor, cause the processor to:
receive a request from the registered business for feedback from the registered feedback provider concerning at least one of goods and services provided by the registered business prior to receiving the request from the registered business to provide the at least one universal credit;
send the request to the registered feedback provider;
receive feedback from the registered feedback provider concerning at least one of goods and services provided by the registered business;
forward the feedback to the registered business; and
receive an acknowledgement from the registered business that the feedback has been accepted.

20. The rewards-based feedback incentive system of claim 18, wherein the memory stores additional instructions that, when executed by the processor, cause the processor to:
receive a request from the registered feedback provider to reserve an electronic coupon of a first registered business to produce a requested coupon, the requested coupon being stored in a data record of the first registered business and valued at a first predetermined number of universal credits;
verify that the account of the registered feedback provider contains at least the first predetermined number of universal credits;
block access to the requested coupon and the first predetermined number of universal credits in the account of the registered feedback provider to produce a coupon reservation; and
inform the first registered business of the coupon reservation.

21. The rewards-based feedback incentive system of claim 18, wherein the memory stores additional instructions that, when executed by the processor, cause the processor to:
receive a search query from a potential feedback provider, the query containing at least one of a business name, a business type, and at least one keyword;
search the database for registered businesses corresponding to the search query; and
present a listing of registered businesses corresponding to the search query to the potential feedback provider, the listing containing information related to each registered business listed therein.
